(19) United States
(12) Patent Application Publication
(10) Pub. No.: US 2018/0136544 A1
(43) Pub. Date: May 17, 2018

(54) LIGHTING DEVICE FOR 360 DEGREE PHOTOGRAPHY

(71) Applicant: Stephen Mink, Cave Spring, GA (US)

(72) Inventor: Stephen Mink, Cave Spring, GA (US)

(21) Appl. No.: 15/808,728

(22) Filed: Nov. 9, 2017

Related U.S. Application Data
(60) Provisional application No. 62/420,757, filed on Nov. 11, 2016.

(51) Int. Cl. G03B 15/05; F21V 11/00; F21S 9/02; F21S 4/28; G03B 17/56; F21V 21/005; F21V 17/12; F21V 23/00

(52) U.S. Cl. CPC G03B 15/05; F21V 11/00; F21S 9/02; F21S 4/28; F21Y 2107/30; F21V 21/005; F21V 17/12; F21V 23/003; G03B 17/561

(57) ABSTRACT

A 360-degree light apparatus, comprising a body comprising a hollow tube having an exterior surface, a first end, and a second end, a first endcap removably attached to the first end of the hollow tube, a second endcap removably attached to the second end, a light source secured to a predetermined portion of the exterior surface of the hollow tube, and a computing device secured within the hollow tube electrically connected to the light source.

### BACKGROUND

The present invention relates to an apparatus for photography lighting, and more particularly to a light apparatus for 360-degree lighting.

A 360-degree photo is a controllable panoramic image that surrounds the original point from which the shot was taken. 360-degree photos simulate being in the shoes of a photographer and looking around to the left, right, up and down as desired as well as sometimes zooming. The photos are lined up to make for a continuous circle around the point of shooting.

360-degree photos are effective for showing off vistas, internal architecture and more in a dramatic fashion that replicates the experience of being there. The ability to create 360-degree photos is increasingly included in digital cameras and smart phones.

As photography equipment continues to advance, the ability to produce full 360-degree photos and videos has created new issues. Many 360-degree cameras use multiple lenses, this create issues with each lens having a different amount of light exposure resulting in a picture with light distortion, glare, and discoloration. With 360-degree cameras that use one lens, the light sources may still affect the quality and exposure of the photo.

Thus, a device that assists the photographer to produce an image that has continuous and even light exposure throughout the entire image is desired to correct this issue.

### SUMMARY

A first embodiment of a 360-degree light apparatus, comprising, a body having a first end and a second end and an exterior surface, wherein a first fastening mechanism is integrated into the first end and a second fastening mechanism is integrated in the second end, a light source secured to a predetermined portion of the exterior surface of the body, and a controller attached to the light source for controlling the light source.

A 360-degree light apparatus, comprising, a body comprising, a hollow tube having an exterior surface, a first end, and a second end, a first endcap removably attached to the first end of the hollow tube, a second endcap removably attached to the second end, a light source secured to a predetermined portion of the exterior surface of the hollow tube, and a computing device secured within the hollow tube electrically connected to the light source.

### BRIEF DESCRIPTION OF THE SEVERAL VIEWS OF THE DRAWINGS

FIG. 1 depicts a perspective view of a 360-degree lighting apparatus, in accordance with one embodiment of the present invention.

FIG. 2 depicts an exploded view of a 360-degree lighting apparatus, in accordance with one embodiment of the present invention.

FIG. 3 depicts a section view of the 360-degree lighting apparatus, in accordance with an embodiment of the present invention.

FIG. 4 depicts a bottom view of a light rod, in accordance with an embodiment of the present invention.

FIG. 5 depicts a top view of the light rod, in accordance with an embodiment of the present invention.

FIG. 6 depicts a perspective view of the 360-degree lighting apparatus, in accordance with another embodiment of the present invention.

FIG. 7 depicts a diagram of electrical components of the 360-degree lighting apparatus, in accordance with an embodiment of the present invention.

### DETAILED DESCRIPTION

The present invention relates to a lighting apparatus designed for a 360-degree camera so that when the camera is collecting one or multiple pictures of the surroundings, the lighting can be substantially continuous throughout the photo(s). This produces a cleaner, less distorted image, due to the fact, that the camera does not need to constantly be readjusting the various factors that affect light exposure, e.g. the aperture, shutter speed, and ISO setting of the camera. The current device is designed to produce a consistent or controlled amount of light so that the camera can produce a cleaner and more continuous image.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, the preferred methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

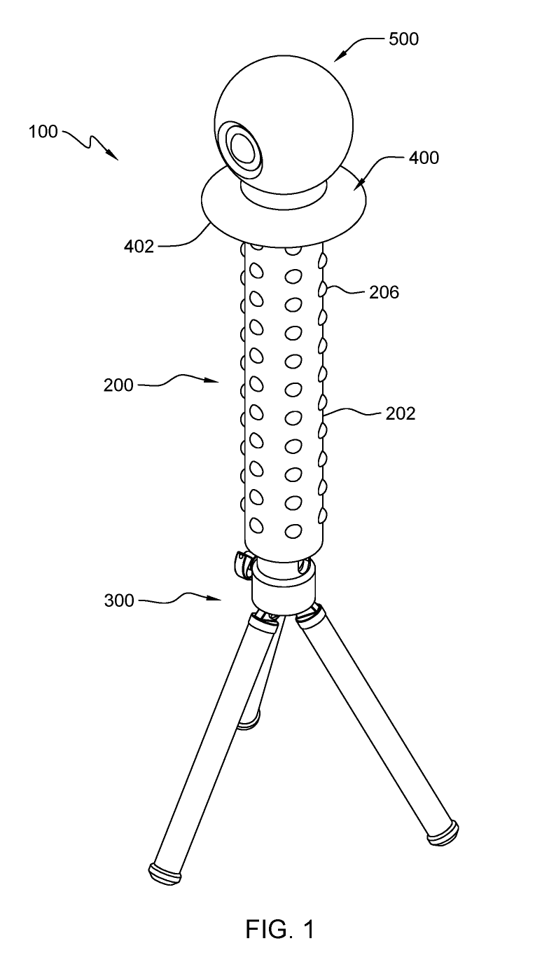

FIG. 1 depicts a perspective view of a 360-degree lighting apparatus 100 assembly, in accordance with one embodiment of the present invention. The 360-degree lighting apparatus 100 is comprised of, in one embodiment, a camera 500, a deflection disk 400, a base support 300, and a light rod 200. In the depicted embodiment the camera 500 is attached to the light rod 200 with the deflection disk 400 secured between them, and the light rod 200 is attached to a base support 300. In additional embodiments, various of elements and parts may be incorporated into the assembly. The base support 300 and the camera 500 are shown as examples and are in no way limiting on the type of elements in the 360-degree lighting apparatus 100. The camera 500 may be various designed, such as, but not limited to, 360-degree cameras or other means of still or video cameras that could benefit from the light rod's 200 lighting. The base support 300, may be various types of supports known to those skilled in the arts such as, but not limited to, tripods, bipods, suction supports, locks, latches, fasteners, or the like which can be used to attached or secure the 360-degree lighting apparatus 100 to a surface or structure.

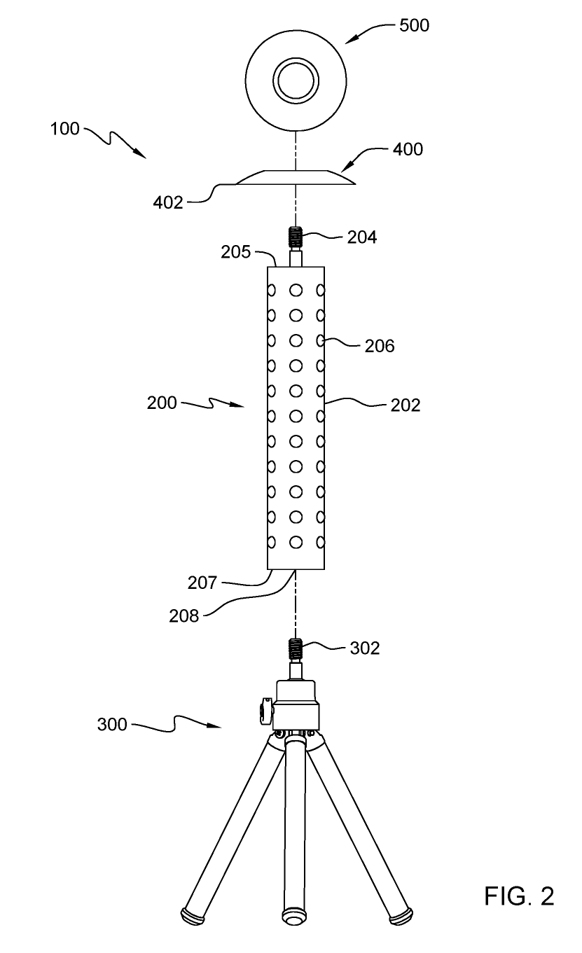

FIG. 2 depicts an exploded view of the 360-degree lighting apparatus 100, in accordance with an embodiment of the present invention. The 360-degree lighting apparatus 100 is comprised of the light rod 200, and the deflection disk 400. In the depicted embodiment, the light rod 200 is comprised of a body 202, a plurality of light sources 206, a first attachment means 204, and a second attachment means 208.

The body 202 provides a structure for the light sources 206 to be secured to the surface of or unitarily integrated with to provide the desired light for the environment and the camera 500, to produce clear and detailed photos. In the depicted embodiments, the body 202 is, a substantially circular design and has a predetermined length. In additional embodiments, the body 202 may have different shapes or lengths based on the amount of light which needs to be produced or specific lighting setups which need to be created. In some embodiments, the body 202 exterior surface is adjustable allowing the operator to adjust the contour of the exterior surface to produce customizable and specific light setups. The body 202 provides a hollow structure for the electrical components to be securely and safely contained inside. In some embodiments, the body 202 is a water tight and air tight design. In additional embodiments, the body 202 has a top and bottom cover which are removable to allow access to the internal compartment and components of the body 202. In the depicted embodiment, the light sources 206 are integrated into the surface of the body 202. In some embodiments, the light source 206 is attached or fastened to the body 202 to allow for efficient replacement of the light source(s) 206. The body 202 may be various lengths, diameters, and sizes based on the intended application. In the depicted embodiment, the body 202 is a unitary design having the top, bottom, and side as a unitary element. In additional embodiments, a top plate a bottom plate is removably secured to the body 202 to allow access to the internal compartment of the body 202. In some embodiments, the light sources 206 covers a predetermined portion of the body 202 that is less than the entire surface of the body 202. In some more embodiments, where the light sources 206 do not cover the entire surface of the body 202 a handle may be attached to the body 202 to allow the operator to securely hold the light rod 200.

In the depicted embodiment, the body 202 has a first attachment means 204 located on the top end 205 which is represented by a threaded rod. The first attachment means 204 allows for the camera 500 to be secured to the light rod 200, and allows for the attachment of the deflection disk 400. In additional embodiments, various types of fasteners or attachment means may be employed, such as, but not limited to threaded rods, locks, latches, magnets, pins or the like know to one of ordinary skill in the art. In the depicted embodiment, the bottom surface 207 of the body 202, a second attachment means 208 (not shown) is positioned to secure attachment to the base support 300. In the depicted embodiment, the base support 300 has a threaded rod 302 which the second attachment means 208 interlocks with. In additional embodiments, various types of attachment means may be employed.

The body 202 may be made from, but not limited to, stainless steel, polyolefins, styrenics, polypropylene, copolymer polypropylene, polystyrene, thermoplastic elastomers, thermoplastic elastomers, polyethylene, polypropylene, polystyrene, copolymer polypropylene, or other weather proof materials known to those of skill in the art.

The light source 206 is designed to produce a directional light based on the placement along the surface of the body 202. In the depicted embodiment this is a substantially equal amount of light throughout the area in which the 360-degree lighting apparatus 100 is placed to create a 360-degree image with substantially equal lighting throughout the entire image or video. In one embodiment, the light source 206 is secured to the body 202 with an adhesive or other method known to those skilled in the art. In additional embodiments, the light source 206 is integrated with the body 202 creating a unitary element. In the depicted embodiment, the light source 206 covers substantially the entire exterior surface of the body 202 and is shown in a substantially equal grid style pattern. In various other embodiments, the light source 206 may cover a predetermined portion of the body 202, the individual lighting elements of the light source 206 may also have varying patterns and structures. In the depicted embodiment, the light source 206 is light emitting diodes (LED). In additional embodiments, the light source 206 can be various of forms of lights, such as, fluorescent, incandescent, or the like known to those skilled in the arts. The light source 206 may be able to adjust the brightness, color, strobe effect, pulsate, select individual diodes, flash, or perform other functions than just being on or off. In one embodiment, the light source 206 is integrated into the body 202 and form a unitary constructed component.

In additional embodiments, a sleeve (not shown) may cover the light source 206 and the body 202 for protection or for a desired effect depending on the transparency, color, structure, and the various other features of the sleeve.

The deflection disk 400 is designed to deflect, redirect or block a portion of the light from directly entering the camera lens and causing an undesirable effect on the image or video captured(s). In some instances, if the light source 206 is to bright or close to the lens, this will result in a negative effect on the quality and clarity of the captured image. The deflection disk 400, deflect a portion of the light created by the light source 206 from directly entering the camera lens. The deflection disk 400, has a predetermined diameter, curvature (e.g. concave or convex) and shape to provide the desired effect. The deflection disk 400 has means to be secured to the light rod 200, the camera 500, or be secured between them. In one embodiment, the deflective disk 400 has an opening (not shown) which is designed to fit over the first attachment means 204. In additional embodiments, the deflection disk 400 is magnetized, or may have various fastening means or adhesives to properly secure the deflection disk 400 to the body 202, the first attachment means 204, or the camera 500. In the depicted embodiment, the deflection disk 400 has a concave shape. In additional embodiments, the deflection disk 400 has various shapes and sizes based on the desired effect on the captured image. In some embodiments, the deflection disk 400 can have anti-glare coating, or other optical coatings to create a desired effect. The deflection disk 400 can be made from, but not limited to, polyethylene, polyethylene terephthalate, high-density polyethylene, polypropylene, polystyrene, polyvinyl chloride, polyurethane, poly carbonate, polybutylene terephthalate, acrylonitrile styrene acrylate, acrylics, aluminum, steel, cooper, or various other metals, a combination of plastics and metals, or the like.

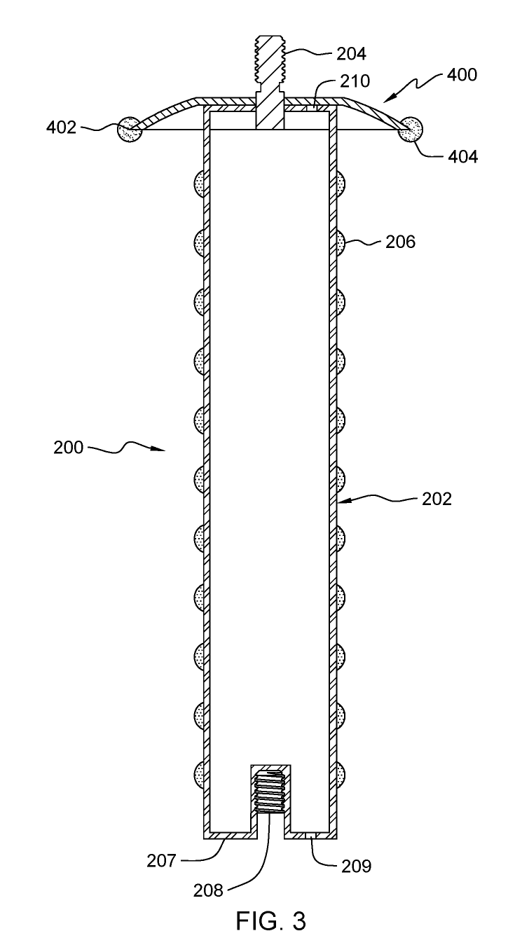

FIG. 3 depicts a section view of the light rod 200 and the deflection disk 400, in accordance with an embodiment of the present invention. In the depicted embodiment, the light rod 200 interior compartment is shown, showing the hollow design to hold the electrical components, and may also be used for storage depending on the size of the light rod 200. The second attachment means 208 is shown as a female threaded opening. Additionally, at least one electrical port 209 is shown exposed along the bottom surface 207 to allow the operator to connect the electrical components to an additional power source or computing device and the top surface 205 has an opening 210 to allow for additional electrical interfaces to be exposed on the external surface of the light rod 200. In additional embodiments, the electrical port 209 may be positioned to be accessible on other surfaces of the light rod 200, and may be used for various electrical connection purposes to upload or download data, or to power an internal battery. In some embodiments, where a plurality of 360-degree lighting apparatuses 100 are connected in a series, the top surface 205 and bottom surface 207 have mating electronic connectors in predetermined locations so that the multiple 360-degree lighting apparatuses 100 can be electronically and mechanically controlled for operational purposes.

In the depicted embodiment, the deflection disk 400 has a bumper 404 secured around the edge 402. The bumper 404 may be, but not limited to, a rubber or shock absorbing coating or material that is secured along the edge 402 to protect the camera 500 in the event the lighting device is knocked over or falls. The bumper 404 is designed to absorb some of the shock of the deflection disk 400 hitting a hard surface.

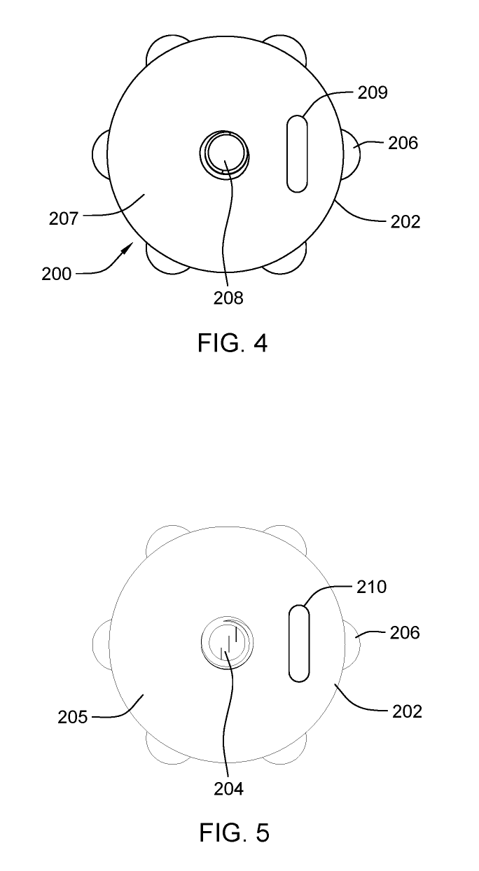

FIG. 4 depicts a bottom view of the light rod 200 and the deflection disk 400, in accordance with an embodiment of the present invention. In the depicted embodiment, the opening 209 is shown as an oblong opening to allow for electrical connection between the internal components. In various other embodiments, the opening 209 may have various shapes and locations.

FIG. 5 depicts a top view of the light rod 200 and the deflection disk 400, in accordance with an embodiment of the present invention. In the depicted embodiment, the opening 210 is shown as an oblong opening to allow for electrical connection between the internal components. In various other embodiments, the opening 210 may have various shapes and locations.

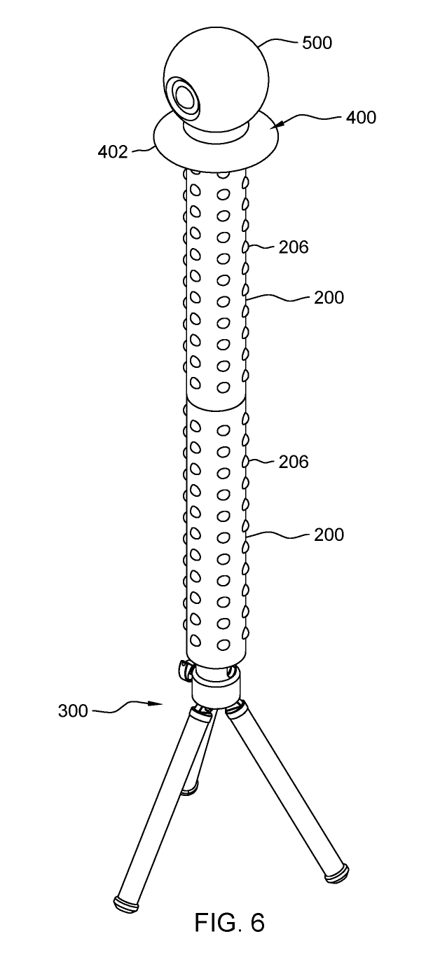

FIG. 6 depicts a perspective view of the 360-degree lighting apparatus 100, in accordance with another embodiment of the present invention. As shown in the depicted embodiment, a plurality of light rods 200 are attached to one another. This provides both a taller base for the camera 500 to be mounted on, and the light source 206 with the ability to produce more light. The light rods 200 are connected through the attachment means 206 and 208 mating with one another to secure the light rods 200 together. In additional embodiments, the light rods 200 are connected electronically through the electrical connections exposed through openings 209 and 210. In some embodiments, the operator is able to adjust the light sources 206 of both or one of the light rods 200 at a time. In some embodiments, the light rod 200 may be attached to another element to allow for versatility in the applications the operate can use the light rod 200. For example, they may attach a selfie stick to the light rod 200.

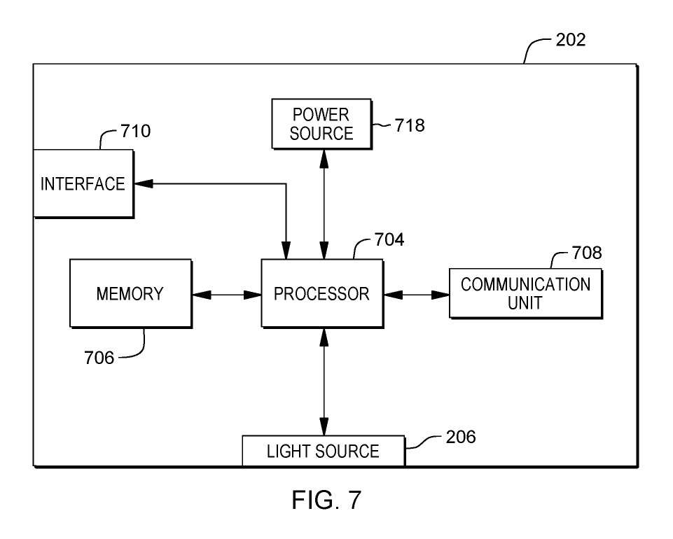

FIG. 7 depicts a diagram of electrical components of the 360-degree lighting apparatus 100, in accordance with an embodiment of the present invention. FIG. 7 depicts a computing device 700, in accordance with an illustrative embodiment of the present invention. In different embodiments, all, some, or none of these components may be encapsulated within the body 102. It should be appreciated FIG. 4 provides only an illustration of one implementation and does not imply any limitations with regard to the environments in which different embodiments may be implemented. Many modifications to the depicted environment may be made.

Computing device 700 includes communications fabric 702, which provides communications between computer processor(s) 704, memory 706, communications unit 708, and input/output 710. The computing system 700 controls the light source 206 and in some embodiments the camera 500.

Communications fabric 702 can be implemented with any architecture designed for passing data and/or control information between processors (such as microprocessors, communications and network processors, etc.), system memory, peripheral devices, and any additional hardware components within a system. For example, communications fabric 702 can be implemented with one or more buses.

Memory 706 is computer-readable storage media. In one embodiment, memory 706 includes random access memory (RAM). In general, memory 706 can include any suitable volatile or non-volatile computer-readable storage media. Memory 706 is stored for execution by one or more of the respective computer processors 704 of computing device 700 via one or more memories of memory 706. Computer processor 704 may have the ability to control the camera 500 and the light source 206 independently or in unison. In additional embodiments, an external computing device or processor may be able to wireless control the camera 500 and the light source 206. Memory 706 can include a magnetic hard disk drive, or a solid state hard drive, a semiconductor storage device, read-only memory (ROM), erasable programmable read-only memory (EPROM), flash memory, or any other computer-readable storage media that is capable of storing program instructions or digital information.

Communications unit 708, in the examples, provides for communications with other data processing systems or devices, including computing device 700. In the examples, communications unit 708 includes one or more network interface cards. Communications unit 708 may provide communications through the use of either or both physical and wireless communications links.

Interface 710 allows for input and output of data with other devices that may be connected to computing device 700. For example, interface 710 may provide a connection to external devices such as a keyboard, keypad, camera, a touch screen, additional 360-degree lighting apparatuses 100, and/or some other suitable input device. In some embodiments the interface 710 is exposed on the top surface 205, bottom surface 207, or the body 202 of the light rod 200.

Power source 718 is connected to the processor 704 to provide adequate power to allow the computing device 700 and the light source 206 to operate. In additional embodiments, the power source 718 may be rechargeable, and may be connected directly to various of elements such as the light source 206.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The invention is inclusive of combinations of the embodiments or embodiments described herein. References to “a particular embodiment” or “embodiment” and the like refer to features that are present in at least one embodiment of the invention. Separate references to “an embodiment” or “particular embodiments” or “embodiments” or the like do not necessarily refer to the same embodiment or embodiments; however, such embodiments are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention. The present invention shall be easily carried out by an ordinary skilled person in the art, and any modifications and changes are deemed to be within the scope of the present invention.

This written description uses examples to disclose the invention, including the best mode, and also to enable any person skilled in the art to practice embodiments of the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

What is claimed is:

1. A 360-degree light apparatus, comprising:
a body having a first end and a second end and an exterior surface, wherein a first fastening mechanism is integrated into the first end and a second fastening mechanism is integrated in the second end;
a light source secured to a predetermined portion of the exterior surface of the body; and
a controller attached to the light source for controlling the light source.

2. The 360-degree light apparatus of claim 1, further comprising a light shield having a lip and removably connected to the first end of the body.

3. The 360-degree light apparatus of claim 2, wherein the light shield has a concave shape.

4. The 360-degree light apparatus of claim 2, further comprising a rubberized coating along an edge of the light shield.

5. The 360-degree light apparatus of claim 1, wherein the body has a substantially circular shape.

6. The 360-degree light apparatus of claim 1, wherein the body has a hollow interior and the controller is secured within the hollow interior of the body.

7. The 360-degree light apparatus of claim 6, further comprising a battery secured within the hollow interior of the body.

8. The 360-degree light apparatus of claim 6, further comprising a first electrical connected exposed on the first end of the body.

9. The 360-degree light apparatus of claim 2, further comprising a bumper secured to an edge of the light shield.

10. The 360-degree light apparatus of claim 6, wherein a second electrical connected exposed on the second end of the body.

11. The 360-degree light apparatus of claim 1, wherein the first end of the body is removably attached to the body.

12. The 360-degree light apparatus of claim 1, wherein the second end of the body is removably attached to the body.

13. The 360-degree light apparatus of claim 1, wherein the light source and the body are a unitary element.

14. The 360-degree light apparatus of claim 1, further comprising a guard secured to the body, wherein the guard covers substantially the entire surface of the body and provides a substantially watertight seal around the body.

15. The 360-degree light apparatus of claim 14, wherein the guard is made from a substantially clear material.

16. The 360-degree light apparatus of claim 1, further comprising a handle secured to the exterior surface of the body.

17. A 360-degree light apparatus, comprising:
a body comprising:
a hollow tube having an exterior surface, a first end, and a second end,
a first endcap removably attached to the first end of the hollow tube,
a second endcap removably attached to the second end,
a light source secured to a predetermined portion of the exterior surface of the hollow tube, and
a computing device secured within the hollow tube electrically connected to the light source.
